(19) United States
(12) Patent Application Publication
(10) Pub. No.: US 2025/0370722 A1
(43) Pub. Date: Dec. 4, 2025

(54) MONITOR-GUIDED DECODING OF CODE LANGUAGE MODELS WITH STATIC ANALYSIS OF REPOSITORY CONTEXT

(71) Applicant: Microsoft Technology Licensing, LLC, Redmond, WA (US)

(72) Inventors: Aditya KANADE, Bangalore (IN); Navin GOYAL, Bangalore (IN); Sriram RAJAMANI, Bangalore (IN); Shuvendu LAHIRI, Redmond, WA (US); Lakshya A. AGRAWAL, Bangalore (IN)

(73) Assignee: Microsoft Technology Licensing, LLC, Redmond, WA (US)

(21) Appl. No.: 18/680,100

(22) Filed: May 31, 2024

(51) Int. Cl. G06F 8/33; G06F 8/75

(52) U.S. Cl. CPC G06F 8/33; G06F 8/75

(57) ABSTRACT

A data processing system implements analyzing program code using a language model to cause the language model to generate a suggestion for completing the program code; monitoring tokens generated by the language model using a code monitor as the language model is generating the tokens, the tokens representing partial code that has been generated by the language model based on the program code; identifying a trigger point in the partial code using the code monitor; querying a static analysis tool using the code monitor to obtain syntactic or semantic constraints for completing the partial code in response to detecting the trigger point, the static analysis tool being configured to provide syntactic and semantic constraints based on repository-level knowledge; and guiding generation of subsequent tokens by the language model based on the constraints to cause the language model to generate a syntactically correct suggestion for completing the program code.

### BACKGROUND

Language Models (LMs) have been used to generate program code for software development. LMs work well for generating code when the surrounding code provides sufficient context to the model. However, LMs struggle to generate correct program code when the code uses types, functionality, or application programming interfaces (APIs) defined elsewhere in a code repository or a linked library. This problem is exacerbated when these types, functionalities, or APIs were not included in the training data used to train the LMs. The LMs suffer from limited awareness of such global context and end up hallucinating. Integrated development environments (IDEs) assist developers in understanding repository context using static analysis. Hence, there is a need for improved systems and methods for generating program code using language models.

### SUMMARY

An example data processing system according to the disclosure includes a processor and a memory storing executable instructions. The instructions when executed cause the processor alone or in combination with other processors to perform operations including obtaining program code that was input into a user interface of an integrated development environment; analyzing the program code using a language model to cause the language model to generate a suggestion for completing the program code; monitoring tokens generated by the language model using a code monitor as the language model is generating the tokens, the tokens representing partial code that has been generated by the language model based on the program code; identifying a trigger point in the partial code using the code monitor; querying a static analysis tool using the code monitor to obtain constraints on generation of subsequent tokens based on repository-level syntactic and semantic knowledge in response to detecting the trigger point; and guiding generation of subsequent tokens by the language model based on the constraints to cause the language model to generate a syntactically and semantically correct suggestion for completing the program code.

An example method implemented in a data processing system includes obtaining program code that was input into a user interface of an integrated development environment; analyzing the program code using a language model to cause the language model to generate a suggestion for completing the program code; monitoring tokens generated by the language model using a code monitor as the language model is generating the tokens, the tokens representing partial code that has been generated by the language model based on the program code; identifying a trigger point in the partial code using the code monitor; querying a static analysis tool using the code monitor to obtain constraints on generation of subsequent tokens based on repository-level syntactic and semantic knowledge in response to detecting the trigger point; and guiding generation of subsequent tokens by the language model based on the constraints to cause the language model to generate a syntactically and semantically correct suggestion for completing the program code.

An example data processing system according to the disclosure includes a processor and a memory storing executable instructions. The instructions when executed cause the processor alone or in combination with other processors to perform operations including monitoring, using a code monitor, tokens generated by a language model in response to a prompt to cause the language model to generate a suggestion for completing program code, the tokens representing partial code that has been generated by the language model based on the program code; querying a static analysis tool using the code monitor to obtain constraints on generation of subsequent tokens based on repository-level syntactic and semantic knowledge; and guiding generation of subsequent tokens by the language model based on the constraints to cause the language model to generate a syntactically and semantically correct suggestion for completing the program code.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram showing an example of program code generation using a language model according to a conventional approach and according to the techniques provided herein.

FIG. 2 is a diagram of a partial abstract syntax tree (AST) for the program code shown in FIG. 1.

FIG. 3 is a diagram of an example computing environment in which the techniques for generating program code using a language model described herein are implemented.

FIG. 4 is a diagram showing the code monitor being used to monitor the tokens being generated by the language model and using masks to modify the logits of the language model for the program code shown in FIG. 1.

FIG. 5A is a flow chart of an example process for generating program code using a language model according to the techniques disclosed herein.

FIG. 5B is a flow chart of another example process for generating program code using a language model according to the techniques disclosed herein.

FIG. 6 is a block diagram showing an example software architecture, various portions of which may be used in conjunction with various hardware architectures herein described, which may implement any of the described features.

FIG. 7 is a block diagram showing components of an example machine configured to read instructions from a machine-readable medium and perform any of the features described herein.

### DETAILED DESCRIPTION

Systems and methods for generating program code using a language model are provided herein. The techniques herein provide a solution to the technical problem associated with generating code with a language model, where the language model hallucinates and generates incorrect program code due to lack of context about the correct syntax and/or semantic constraints for the program code being generated. The technical solutions provided herein provide Monitor-Guided Decoding (MGD) techniques which implement a code monitor that utilizes static analysis to obtain syntactically and semantically correct program code suggestions. The code monitor monitors the tokens associated with program code suggestions as the tokens are generated by the language model, constraining the tokens generated based on the syntactic and semantic validity of the generated tokens. The code monitor queries a static analysis tool in the background to obtain syntactic/semantic constraints based on repository-level knowledge. The code monitor generates token masks based on the syntactic/semantic constraints and uses these masks to modify the value of logits of the language model to guide the language model to generate syntactically and semantically correct program code suggestions and to avoid hallucinating invalid program code selections. A technical benefit of this approach is that the training and/or structure of the language model does not need to be modified to implement these techniques. Consequently, the accuracy of the code generated by the language model can be significantly improved without having to obtain costly labeled training data and without having to utilize a significant amount of computing resources to train the model on this training data. Another benefit of these techniques is that the code monitor can help smaller language models that have few parameters outperform larger language models that are not paired with the code monitors. As a result, smaller language models that require fewer computing resources to implement can be utilized to provide code completion. Some instances of these language models are small enough to be implemented locally on the software developer's computing device rather than relying on much larger language models that are implemented remotely on a cloud-based computing environment. A technical benefit of this approach is increased data privacy because code completions can be served locally, and the program code does not need to be send to a cloud-based server for analysis. Another technical benefit of the technique provided herein is that these techniques are language agnostic and can be utilized with a wide variety of programming languages. These and other technical benefits of the techniques disclosed herein will be evident from the discussion of the example implementations that follow.

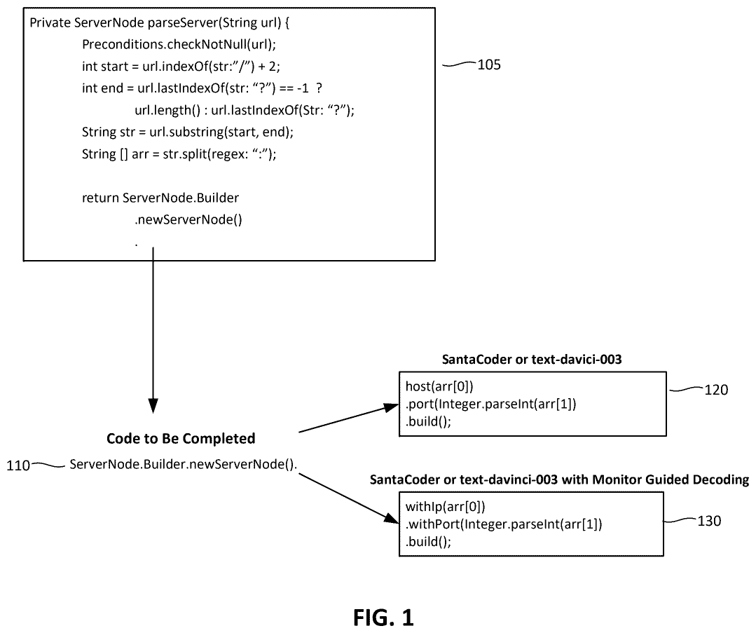

FIG. 1 is a diagram showing an example of program code generation using a language model according to a conventional approach and according to the techniques provided herein. In the example shown in FIG. 1, code is being edited in a user interface of an integrated development environment (IDE) 105. The IDE is a software application that facilitates software development. One of the features provided by the IDE 105 is code completion. Code completion presents context sensitive suggestions for completing the program code being entered in the IDE 105. In the example shown in FIG. 1, the user is inputting a return statement which makes a call to ServerNode.Builder.newServerNode( ) The program code to be completed 110 is analyzed using a language model trained to output a suggestion for completing the program code to be completed 110. The input to the language model may include all or a part of the program code file available in the IDE and is not limited to just the program code to be completed 110. The size of the input to the language model may be limited by the context window size of the language model.

FIG. 1 shows a comparison of the output 120 of the SantaCoder language model and the text-davici-003 language model and the output 130 using the code monitor provided herein. SantaCoder has 1.1 billion parameters, while text-davinci-003 has 175 billion parameters. To complete the code shown in this example, the language model has to generate identifiers consistent with the type of object returned by ServerNode.Builder.newServerNode( ) The method newServerNode and its return type, class ServerNode.Builder, are defined in another file. If the language model does not have information about the ServerNode.Builder type, it ends up hallucinating and providing an incorrect suggestion.

FIG. 1 shows the output 120 that is generated using the SantaCoder language model and the text-davici-003 language model. In this example, the SantaCoder model did not have information about the ServerNode.Builder type and ended up hallucinating an incorrect suggestion. The completion in output 120 uses host and port, which do not exist in the ServerNode. Builder type. The generated code would therefore result in a “symbol not found” compilation error. The lack of awareness of other semantic information from the global context may also result in other kinds of errors such as but not limited to compile-time errors (e.g., invoking a method with the wrong number of arguments) or runtime errors (e.g., an IllegalStateException due to violation of the API protocols).

The output 130 is instead generated using the SantaCoder model with the code monitor disclosed herein to obtain information from a static analysis tool that facilitates generation of valid code completion selections. The static analysis tool provides information on constraints on the generation of subsequent tokens based on repository-level syntactic and semantic knowledge. The code monitor then uses this constraint information to guide the language model to generate program code that conforms to these constraints. The code monitor converts the constraint information to token masks to modify the logits of the language model to guide the language model toward generating valid code in some implementations. Additional details of how the code monitor guides the language model are provided in the examples which follow.

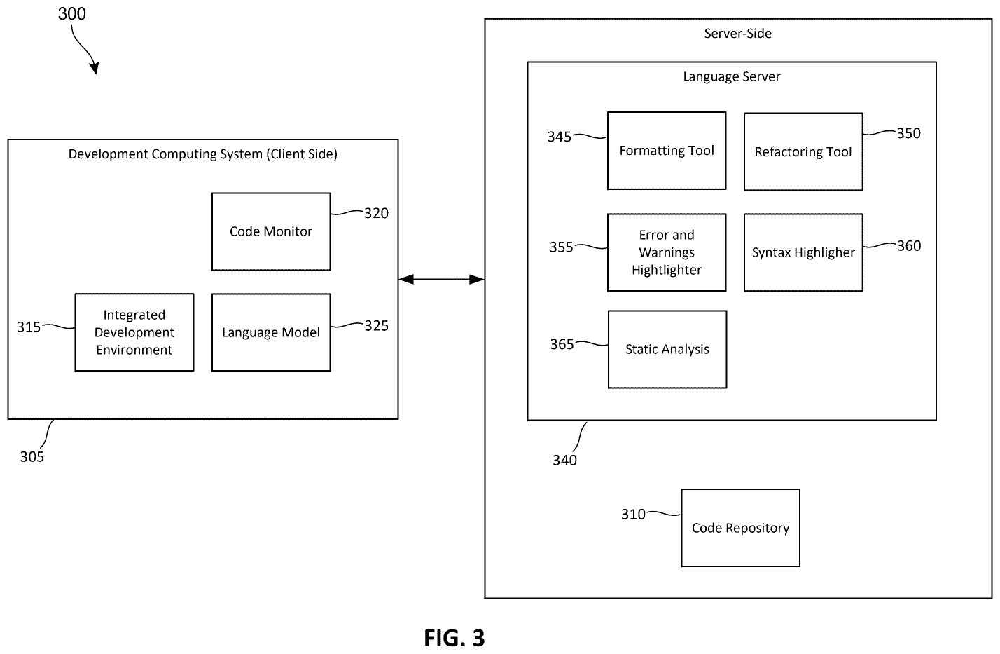

The code monitor provided herein relies on static analysis of code. Static analysis is a means for analyzing program code without actually executing the program code. IDEs commonly apply static analysis to partial code that is under development. The IDEs often rely on static analysis tools which are implemented by a language server. The IDE communicates with these tools using Language Server Protocol (LSP). The static analysis tools use various algorithms for incrementally parsing and semantic analysis of partial code. The static analysis tools can verify that the partial program code input by the user is syntactically and/or semantically correct. The static analysis tools can also provide suggestions for code completion, as discussed in the preceding examples, and/or other services such as but not limited to code formatting, code refactoring, code compilation, syntax highlighting, and/or other such features. An example of such a language server is shown in FIG. 3, which is discussed in detail in the examples which follow.

A key abstraction that is used in the analysis of partial code is partial abstract syntax trees (ASTs) which provides a tree representation of the partial program code with special nodes that indicate the incomplete parts of the program code. The ASTs are further decorated by semantic information through attribute grammar that decorate each AST node with attributes that capture the static semantics not captured in context-free grammar, such as but not limited to consistency of types among expressions in an assignment. These attributes can include computing the type-hierarchy for object-oriented languages, binding the variables in AST node to their declarations, resolving the types of expressions as well as computing the def-use relationships for resolved AST nodes.

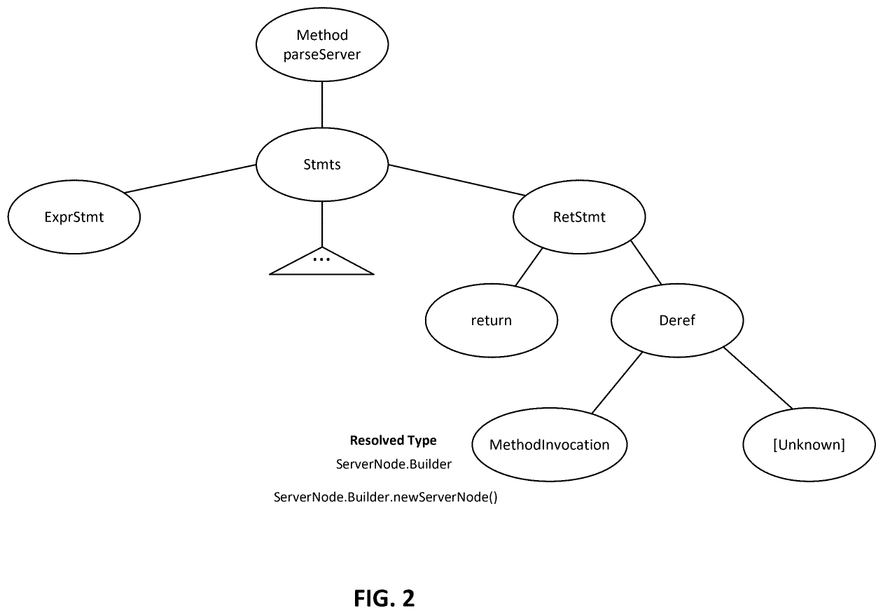

FIG. 2 is a diagram of an example partial AST for the incomplete code shown in FIG. 1. All of the statement in the code being edited by the IDE 105 shown in FIG. 1 up to the return statement have been completely parsed. The subtree for the return statement includes the [UNKNOWN] indicating the incomplete part of the code. An incremental semantic analysis resolves the type of the partial expression ServerNode.Builder.newServerNode( ) to the ServerNode.Builder. As discussed in greater detail in the examples which follow, this information can be used to construct a monitor, which can then be used to guide a language model to generate type-consistent identifier completions.

FIG. 3 is a diagram of an example computing environment 300 in which the techniques for generating program code using a language model described herein are implemented. On the client side, the computing environment includes a development computing system 305, and on server side, the computing environment includes a language server 340 and a code repository. The server-side components may be hosted locally on a local network or hosted remotely on a remove server or cloud-based computing environment. Furthermore, the language server 340 and/or the code repository 310 may be hosted locally on the client side in some implementations.

The development computing system 305 is a computing device that includes an IDE 315, a code monitor 320, and a language model 325. The development computing system 305 can be used by a software developer to write and/or modify program code using the IDE 315. The development computing system 305 may be a laptop computer, desktop computer, tablet computer, or other type of computing device capable of building the code repository 310, an IDE 315, a code monitor 320, and a language model 325. In other implementations, the development computing system 305 may be implemented on a server, and users may access the IDE 315 and/or other components of the development computing system 305 from a client device. The language model 325 can also be hosted on the server side in some implementation. The language model 325 can be implemented on a cloud-based platform, which can be the same platform or a different platform that supports the language server 340.

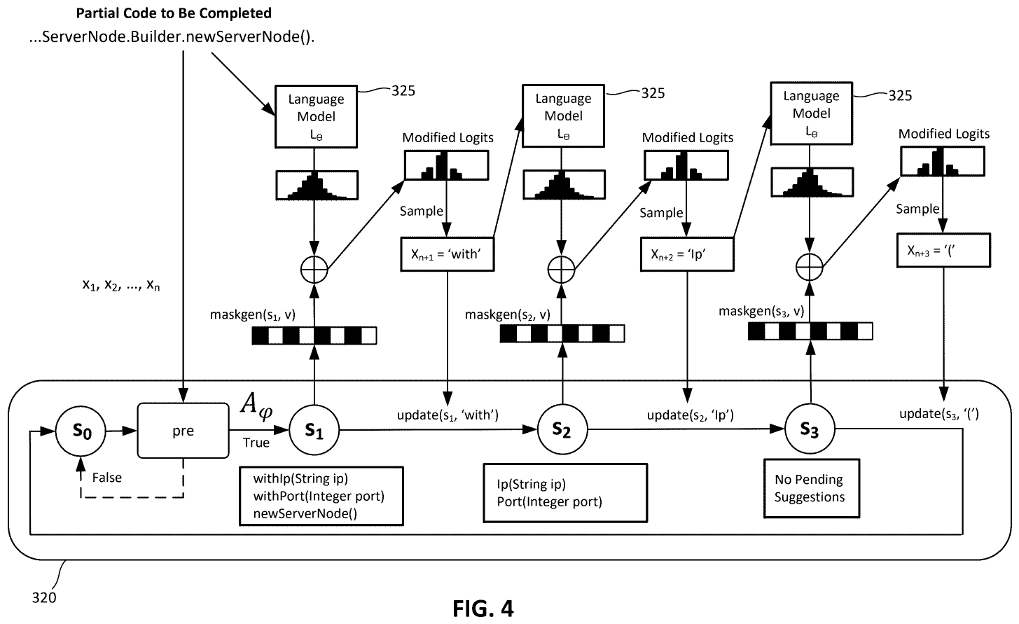

The language model 325 is a generative model that is capable of generating program code in response to a prompt. The prompt specifies the code to be generated by the model. As discussed in the preceding examples, the language model 325 can be used to generate code completions which are guided by the code monitor 320. The language model 325 can be implemented by a language model for which the logits or token-generation probabilities can be accessed and/or modified by the code monitor 320. Logits are unnormalized final scores generated by the model. FIG. 4, discussed below, provides an example implementation of the code monitor 320 that shows how the code monitor 320 generates masks to modify the logits of the language model 325. The language model 325 can be implemented on the development computing system 305 in some implementations, such as that shown in FIG. 3, or may be implemented on a remote cloud-based computing environment accessible over a network connection in other implementations. A technical benefit of pairing the code monitor 320 with the language model 325 is that a less complex or smaller language model can be utilized but still provide results that meet or exceed those of a large language model that is not paired with the code monitor 320. Smaller models require fewer computing resources. Consequently, it is possible for the language model 325 to be implemented locally on the development computing system 305 rather than a cloud-based computing environment typically required to large language models.

The code repository 310 is a persistent datastore for storing program code and other software assets. These assets can include but are not limited to documentation, test data, and scripts. The code repository 310 is shown stored on the server-side in the example shown in FIG. 3, but the code repository 310 may be implemented on the development computing system 305 in FIG. 3 in some implementations. The IDE 315 and the language server 340 can access the contents of the code repository 310.

The language server 340 includes various tools that can be accessed by the IDE 315. The IDE 315 communicates with the language server 340 using LSP. The implementation shown in FIG. 4 includes several tools including a formatting tool 345, a refactoring tool 350, an error and warnings highlighter tool 355, a syntax highlighter tool 360, and a static analysis tool 365. Other implementations of the language server 340 can provide a different set of tools. The formatting tool 345 assists the user in formatting the program code according to a preferred layout. The refactoring tool 350 assists the user in identifying and applying various refactoring techniques to improve the source code. The error and warnings highlighter tool 355 highlights errors and/or warnings in the source code to draw the attention of the user to issues that may need to be addressed in the program code. The syntax highlighter tool 360 selectively highlights various program code elements in different colors to help the user to quickly identify those elements in the program code. The static analysis tool 365 provides syntactically and semantically correct candidate suggestions based on repository-level knowledge. The static analysis tool 365 can provide correct selections based on types, functionality, and/or APIs defined in the repository and/or in one or more linked libraries.

The interaction between the code monitor 320 and the language model 325 are described in greater detail in the examples which follow. Assume that the language model 325 (L_{Θ}) is operating on a vocabulary V. Let x₁, . . . , xₙ, be the partial code that has been generated by the language model 325 and xₙ₊₁ be a candidate next token. The term p is used herein to indicate the additional prompt, e.g. the suffix information used in fill-in-the-middle prompting.

A property φ specifies the constraints that a piece of code needs to satisfy. A static analysis A_{φ} checks whether the partial code satisfies φ. If the partial code satisfies φ, then the static analysis tool 365 continues to extend the partial code so that the extended code continues to satisfy φ. The static analysis tool 365 works on the repository context C which not only includes code spread across multiple files in the repository, but also external dependencies and intermediate artifacts (e.g., code binding) generated during the build process. Such repository context is often very large, diverse, and complex. Directly including this context as an input to the language model 325 will result in a very large prompt and will pass the burden of distilling useful information from this information to the language model 325.

A monitor M_{φ} for a property φ is a tuple (A_{φ}, s₀, S, pre, update, maskgen). The monitor starts in the wait state so. When the partial code satisfies the pre-condition pre, the code monitor 320 is triggered and the code monitor 320 invokes A_{φ} on the partial code. The code monitor 320 maintains the suggestions returned by A_{φ} in the persistent state of the code monitor 320 and uses these suggestions to guide sampling of the next token xₙ₊₁. Let S be the set of states and s, s′∈S respectively be the current and next state of the code monitor 320. With each sampled token xₙ₊₁, the code monitor 320 updates its state using a function update (s, xₙ₊₁) to a new state s′, which tracks the residual suggestions after the token xₙ₊₁ is output. When the suggestions are exhausted, the code monitor 320 reverts back to the wait state s₀. The maskgen functionality is discussed in the examples which follow.

During the decoding process, the next token xₙ₊₁ can be any token from the vocabulary V, sampled based on the logits [symbol] determined by the language model 325. Unlike the usual decoding using just the language model 325, in monitor-guided decoding, the code monitor 320 supervises the code generation using a monitor Mg for a property φ. We denote the composition of L_{Θ} and M_{Θ} by L_{Θ}∥M_{φ}, meaning that both the language model 325 and the code monitor 320 are running concurrently and sampling tokens jointly. The decoding is conditioned on the partial code x₁, . . . , xₙ, the repository context C, the prompt p, and the current state s of the monitor.

Equation (1) states that whenever the monitor is the in the wait state so, the code monitor 320 samples the next token xₙ₊₁ as per the logits [symbol] determined by the language model 325. Otherwise, the logits are combined with a mask m using a function ⊕ such that if m[x]=0 then [symbol] [x] is reset to a large negative value-K. The logits are left unchanged otherwise. The code monitor 320 computes the mask using the function maskgen in Equation (3) guided by the current state s of the monitor. Equation (4) defines how the state of the monitor evolves. When the precondition pre (s; x₁, . . . , xₙ) evaluates to true, the next state s′ of the monitor is determined by the suggestions returned by the static analysis A_{φ}. Otherwise, the next state of the code monitor 320 is determined by the update function.

$$( {L}_{Θ} \vert {M}_{φ} ) ( {x}_{n + 1} \vert {x}_{1} , … , {x}_{n} ; C , p , s ) = \{ \begin{matrix}softmax ( ℓ ) [ {x}_{n + 1} ] if s = {s}_{0} is the wait state \\ softmax ( ℓ ⊕ m ) [ {x}_{n + 1} ] otherwise\end{matrix} \qquad ( 1 )$$

$$ℓ = {L}_{Θ} ( \cdot \vert {x}_{1} , … , {x}_{n} ; p ) \qquad ( 2 )$$

$$m = maskgen ( s , V ) \qquad ( 3 )$$

$${s}^{′} = \{ \begin{matrix}{A}_{φ} ( {x}_{1} , … , {x}_{n ,} ; C ) if s = {s}_{0} ⋀ pre ( s ; {x}_{1} , … , {x}_{n} ) \\ update ( s ; {x}_{1} , … , {x}_{n} ) otherwise\end{matrix} \qquad ( 4 )$$

The specifics of the monitor state, and the pre, update, and maskgen functions depend on the static analysis A_{φ} used by the monitor. The formulation used herein is general and even allows combining multiple static analyses by taking a product of the state-spaces of their respective monitors. In the examples which follow, a specific instantiation of this framework of monitor-guided decoding is discussed.

The techniques herein can also be used for monitoring for the use of type-consistent identifiers. When an object obj of type T is dereferenced, the next token (or the sequence of tokens) should refer to an identifier of a field or method defined by the type T. Otherwise, a “symbol not found” error may result when the code is interpreted or compiled. The type T could be defined in another package, imported file, or in a library. Unless T comes from a popular library seen during training, the language model 325 may not have knowledge about T.

The monitor M_{φ} is triggered when the partial code ends with a partial object dereference expression “obj.” where “.” is the dereference operation. The monitor employs a static analysis A_{φ} which returns all the type-consistent identifiers that can be referenced through the obj. For this, A_{φ} performs a global analysis over the partial code, imported files, libraries used, and class hierarchies to infer the type T of the obj and the identifiers accessible through T. The set of the type-consistent identifiers returned by A_{φ} forms the state of the monitor (see Equation (4) above).

Given a state s and the vocabulary V of the language model 325, maskgen identifies all of the tokens in V that are consistent with the suggestions in s. The identifiers returned by the static analysis are tokens as per the programming language, whereas the vocabulary V may use its own space of subtokens. The mask m (see equation (3) above) is generated by string matching. For all tokens t∈V that form prefixes of the identifiers in s, the mask value m[t] is set to 1, indicating that they can be sampled. Let E be the set of special symbols that indicate the end of an identifier name, e.g., the symbol ‘(’ in ‘getName(’ or ‘,’ in ‘x,’. Let w be a string s and Σ be the set of all possible characters. If a token t∈V matches the regular expression [symbol] ·E·Σ* then its mask value m[t] is set to 1. For all other tokens t∈V, the mask value is set to 0.

Let xₙ₊₁ be the next token sampled according to the second equation in equation (1) discussed above. If xₙ₊₁contains a symbol from E, indicating that a complete identifier name has been generated in accordance with the set returned by A_{φ}, the monitor reverts to the wait state to wait for the next trigger. Otherwise, the token xₙ₊₁ must be a prefix of the member of s. The update function removes the members in s that are not prefixed by xₙ₊₁, and those prefixed by xₙ₊₁ are updated by pruning the prefix string xₙ₊₁. The resulting set of character strings forms the next state s (see the second equation of (4) above). If A_{φ} returns an empty set to start with, the monitor abandons the current run. Note that a single identifier may need to be generated using multiple tokens.

FIG. 4 shows an example of the interaction between the language model 325 and the monitor on the example shown in FIG. 1. This example illustrates how the complete identifiers names suggested by static analysis are gradually pruned by the monitor to corresponding suffixes in each successive state as the prefixes get generated as tokens.

FIG. 4 is a diagram showing the code monitor being used to monitor the tokens being generated by the language model and using masks to modify the logits of the language model. FIG. 4 shows how the code monitor 320 interacts with the language model 325. Initially, the monitor 320 is in the wait state so. Given the code completion input, x₁, . . . , xₙ, the monitor M_{φ} (implemented by code monitor 320) first evaluates pre (s₀; c₁, . . . , xₙ). Since xₙ=‘.’ (the dot symbol indicates object dereferencing in the Java programming language), pre(s₀; x₁, . . . , xₙ) evaluates to true, and subsequently, in accordance with Equation (4), the static analysis A_{φ} implemented by the static analysis tool 365 is invoked, which determines the input prompt to be in accordance with the property φ, and resolves the type for the completion point to be ServerNode. Builder, as shown in the annotated AST shown in FIG. 2. The static analysis A_{φ} then returns the set of identifiers consistent with the resolved type-{withIp, withPort, newServerNode, . . . }, transitioning the code monitor 320 (M_{φ}) to the state s₁. The monitor M_{φ} then calculates m=maskgen (s₁, V), which masks out, for example, the token host (as inferred by the SantaCoder in FIG. 2). Concurrently, the input is tokenized and the language model 325 L_{Θ} provides inferred logits, [symbol] for the next token. The output logits [symbol] from L_{Θ} and mask m are combined as per the operation [symbol] ⊕ m to obtain the modified logits, which are then softmaxed and a token is sampled (“with” in this case). The monitor then invokes update (s₁; with) to transition to s₂. Note that with the state transition, newServerNode is pruned from the set of identifiers, as the sampled token with does not prefix it. L_{Θ} provides logits for the next token, and the composition of L_{Θ} and M_{φ} is repeated to obtain modified logits, and finally we obtain the sampled token Ip. Since Ip is a prefix of a member in s₂, update (s₂, Ip) transitions to s₃, with s₃={∈}, a singleton consisting of the empty string. Note that the token “(” is consistent with the suggestions in state s₃, since it matches the regular expression [symbol] ·E·Σ*, where [symbol] =ϵ, E represent the set of special symbols that indicate end of an identifier name, and Σ be the set of all possible characters. Following the sample of the token ‘(’, the monitor transitions back to the wait state s₀.

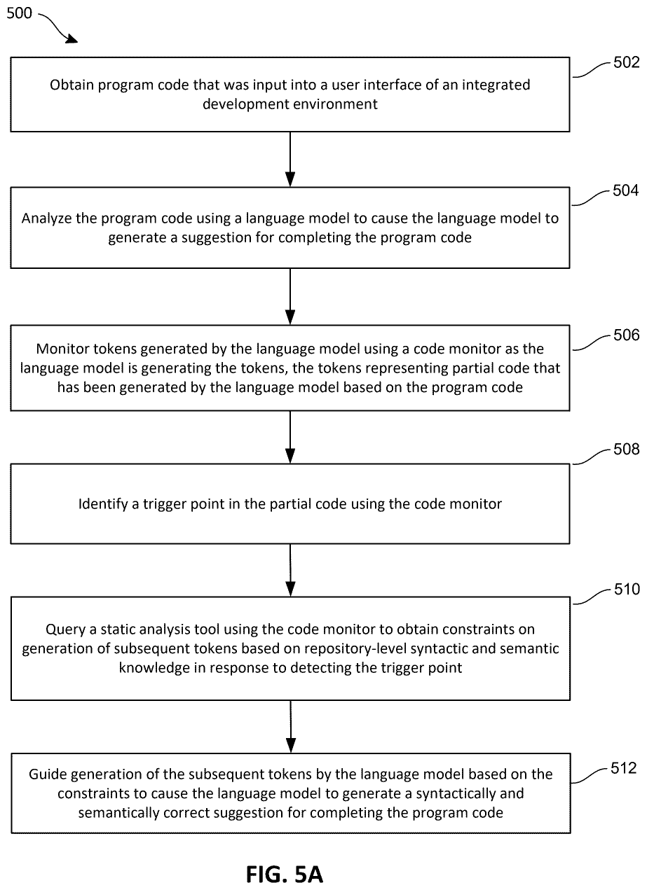

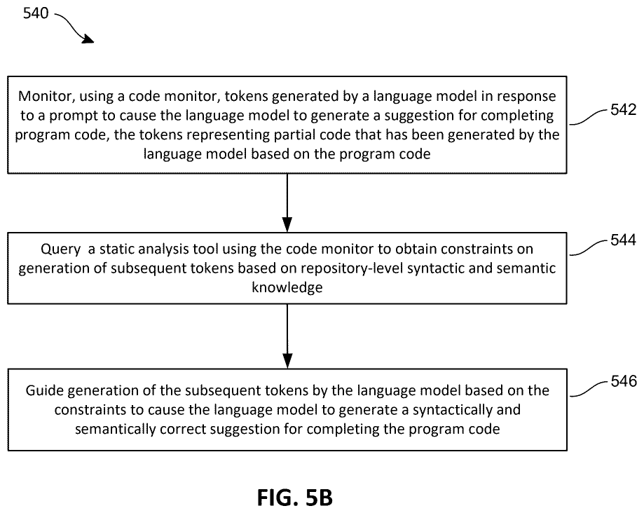

FIG. 5A is a flow chart of an example process 500 for generating program code using a language model according to the techniques disclosed herein. The process 500 can be implemented by the code monitor 320 of the development computing system 305 as discussed in the preceding examples.

The process 500 includes an operation 502 of obtaining program code that was input into a user interface of an integrated development environment. As discussed in the preceding examples, the IDE 315 provides a user interface in which the user may input program code.

The process 500 includes an operation 504 of analyzing the program code using a language model 325 to cause the language model 325 to generate a suggestion for completing the program code. As discussed in the preceding examples, the prompt is constructed for the language model 325 to cause the language model 325 to analyze the program code and to begin generating the suggestion for completing the program code.

The process 500 includes an operation 506 of monitoring tokens generated by the language model using a code monitor as the language model is generating the tokens, the tokens representing partial code that has been generated by the language model based on the program code. The code monitor 320 monitors the tokens generated by the language model 325 as discussed in the preceding examples.

The process 500 includes an operation 508 of identifying a trigger point in the partial code using the code monitor. As discussed above, the code monitor 320 looks for the occurrence of a trigger point, such as but not limited to an “.” indicating that code completion has been requested. In some examples, the trigger point signals an object to be dereferenced.

The process 500 includes an operation 510 of querying a static analysis tool using the code monitor to obtain constraints on generation of subsequent tokens based on repository-level syntactic and semantic knowledge. The code monitor 320 queries the static analysis tool 365 to obtain the syntactically and/or semantically correct candidate suggestions.

The process 500 includes an operation 512 of guiding generation of subsequent tokens by the language model 325 based on the constraints to cause the language model to generate a syntactically and semantically correct suggestion for completing the program code. This is an iterative process and the code monitor 320 may continue to make suggestions until the candidate suggestions are exhausted.

FIG. 5B is a flow chart of another example process 540 for generating program code using a language model according to the techniques disclosed herein. The process 540 can be implemented by the code monitor 320 of the development computing system 305 as discussed in the preceding examples.

The process 540 includes an operation 542 of monitoring, using a code monitor 320, tokens generated by a language model 325 in response to a prompt to cause the language model to generate a suggestion for completing program code. The tokens represent partial code that has been generated by the language model based on the program code.

The process 540 includes an operation 544 of querying a static analysis tool 365 to obtain constraints on generation of subsequent tokens based on repository-level syntactic and semantic knowledge. As discussed in the preceding examples, the static analysis tool 365 is configured to provide constraint information that can be used to guide the language model 325 to generate syntactically correct candidate suggestions based on repository-level syntactic and semantic knowledge.

The process 540 includes an operation 546 of guiding generation of subsequent tokens by the language model 325 based on the constraints to cause the language model to generate a syntactically and semantically correct suggestion for completing the program code.

The detailed examples of systems, devices, and techniques described in connection with FIGS. 1A-5B are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1A-5B are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

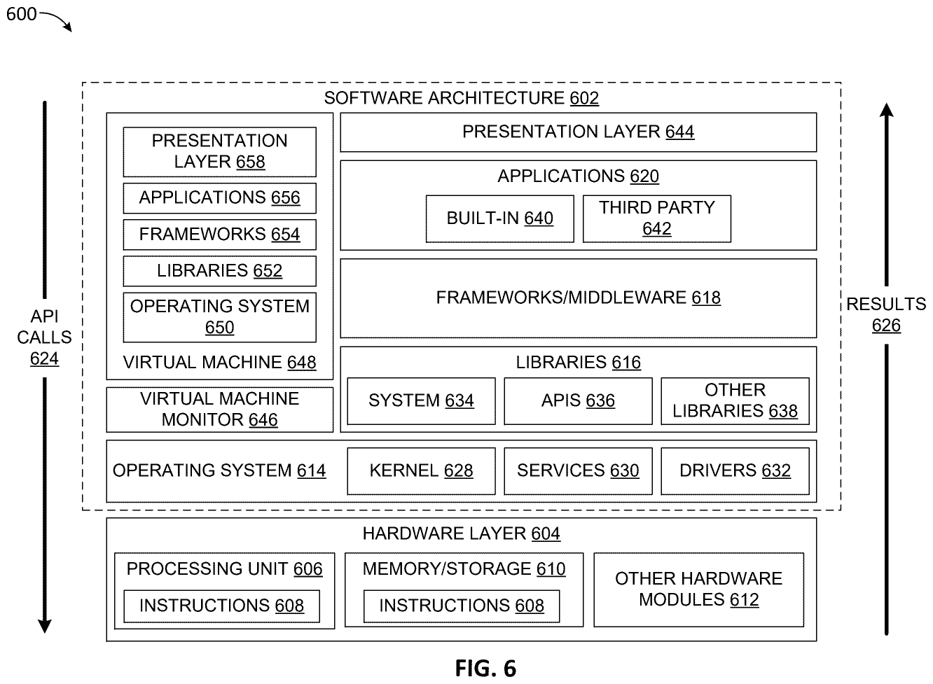

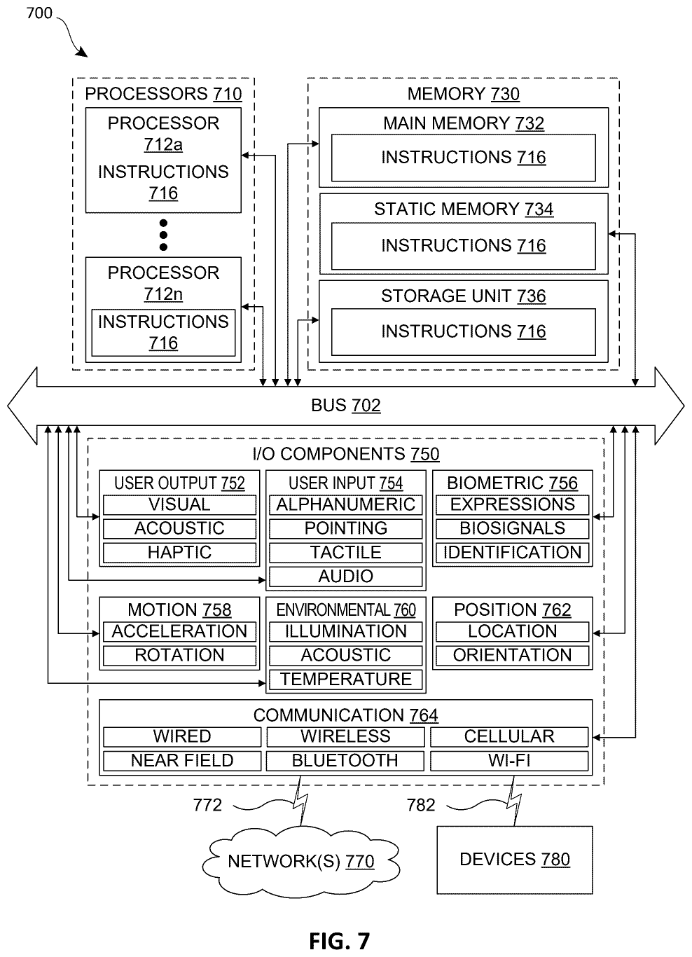

FIG. 6 is a block diagram 600 illustrating an example software architecture 602, various portions of which may be used in conjunction with various hardware architectures herein described, which may implement any of the above-described features. FIG. 6 is a non-limiting example of a software architecture, and it will be appreciated that many other architectures may be implemented to facilitate the functionality described herein. The software architecture 602 may execute on hardware such as a machine 700 of FIG. 7 that includes, among other things, processors 710, memory/storage, and input/output (I/O) components 750. A representative hardware layer 604 is illustrated and can represent, for example, the machine 700 of FIG. 7. The representative hardware layer 604 includes a processing unit 606 and associated executable instructions 608. The executable instructions 608 represent executable instructions of the software architecture 602, including implementation of the methods, modules and so forth described herein. The hardware layer 604 also includes a memory/storage 610, which also includes the executable instructions 608 and accompanying data. The hardware layer 604 may also include other hardware modules 612. Instructions 608 held by processing unit 606 may be portions of instructions 608 held by the memory/storage 610.

The example software architecture 602 may be conceptualized as layers, each providing various functionality. For example, the software architecture 602 may include layers and components such as an operating system (OS) 614, libraries 616, frameworks/middleware 618, applications 620, and a presentation layer 644. Operationally, the applications 620 and/or other components within the layers may invoke API calls 624 to other layers and receive corresponding results 626. The layers illustrated are representative in nature and other software architectures may include additional or different layers. For example, some mobile or special purpose operating systems may not provide the frameworks/middleware 618.

The OS 614 may manage hardware resources and provide common services. The OS 614 may include, for example, a kernel 628, services 630, and drivers 632. The kernel 628 may act as an abstraction layer between the hardware layer 604 and other software layers. For example, the kernel 628 may be responsible for memory management, processor management (for example, scheduling), component management, networking, security settings, and so on. The services 630 may provide other common services for the other software layers. The drivers 632 may be responsible for controlling or interfacing with the underlying hardware layer 604. For instance, the drivers 632 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 616 may provide a common infrastructure that may be used by the applications 620 and/or other components and/or layers. The libraries 616 typically provide functionality for use by other software modules to perform tasks, rather than interacting directly with the OS 614. The libraries 616 may include system libraries 634 (for example, C standard library) that may provide functions such as memory allocation, string manipulation, file operations. In addition, the libraries 616 may include API libraries 636 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 616 may also include a wide variety of other libraries 638 to provide many functions for applications 620 and other software modules.

The frameworks/middleware 618 provide a higher-level common infrastructure that may be used by the applications 620 and/or other software modules. For example, the frameworks/middleware 618 may provide various graphic user interface (GUI) functions, high-level resource management, or high-level location services. The frameworks/middleware 618 may provide a broad spectrum of other APIs for applications 620 and/or other software modules.

The applications 620 include built-in applications 640 and/or third-party applications 642. Examples of built-in applications 640 may include, but are not limited to, a contacts application, a browser application, a location application, a media application, a messaging application, and/or a game application. Third-party applications 642 may include any applications developed by an entity other than the vendor of the particular platform. The applications 620 may use functions available via OS 614, libraries 616, frameworks/middleware 618, and presentation layer 644 to create user interfaces to interact with users.

Some software architectures use virtual machines, as illustrated by a virtual machine 648. The virtual machine 648 provides an execution environment where applications/modules can execute as if they were executing on a hardware machine (such as the machine 700 of FIG. 7, for example). The virtual machine 648 may be hosted by a host OS (for example, OS 614) or hypervisor, and may have a virtual machine monitor 646 which manages operation of the virtual machine 648 and interoperation with the host operating system. A software architecture, which may be different from software architecture 602 outside of the virtual machine, executes within the virtual machine 648 such as an OS 650, libraries 652, frameworks 654, applications 656, and/or a presentation layer 658.

FIG. 7 is a block diagram illustrating components of an example machine 700 configured to read instructions from a machine-readable medium (for example, a machine-readable storage medium) and perform any of the features described herein. The example machine 700 is in a form of a computer system, within which instructions 716 (for example, in the form of software components) for causing the machine 700 to perform any of the features described herein may be executed. As such, the instructions 716 may be used to implement modules or components described herein. The instructions 716 cause unprogrammed and/or unconfigured machine 700 to operate as a particular machine configured to carry out the described features. The machine 700 may be configured to operate as a standalone device or may be coupled (for example, networked) to other machines. In a networked deployment, the machine 700 may operate in the capacity of a server machine or a client machine in a server-client network environment, or as a node in a peer-to-peer or distributed network environment. Machine 700 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 700 is illustrated, the term “machine” includes a collection of machines that individually or jointly execute the instructions 716.

The machine 700 may include processors 710, memory/storage 730, and I/O components 750, which may be communicatively coupled via, for example, a bus 702. The bus 702 may include multiple buses coupling various elements of machine 700 via various bus technologies and protocols. In an example, the processors 710 (including, for example, a central processing unit (CPU), a graphics processing unit (GPU), a digital signal processor (DSP), an ASIC, or a suitable combination thereof) may include one or more processors 712a to 712n that may execute the instructions 716 and process data. In some examples, one or more processors 710 may execute instructions provided or identified by one or more other processors 710. The term “processor” includes a multicore processor including cores that may execute instructions contemporaneously. Although FIG. 7 shows multiple processors, the machine 700 may include a single processor with a single core, a single processor with multiple cores (for example, a multicore processor), multiple processors each with a single core, multiple processors each with multiple cores, or any combination thereof. In some examples, the machine 700 may include multiple processors distributed among multiple machines.

The memory/storage 730 may include a main memory 732, a static memory 734, or other memory, and a storage unit 736, both accessible to the processors 710 such as via the bus 702. The storage unit 736 and memory 732, 734 store instructions 716 embodying any one or more of the functions described herein. The memory/storage 730 may also store temporary, intermediate, and/or long-term data for processors 710. The instructions 716 may also reside, completely or partially, within the memory 732, 734, within the storage unit 736, within at least one of the processors 710 (for example, within a command buffer or cache memory), within memory at least one of I/O components 750, or any suitable combination thereof, during execution thereof. Accordingly, the memory 732, 734, the storage unit 736, memory in processors 710, and memory in I/O components 750 are examples of machine-readable media.

As used herein, “machine-readable medium” refers to a device able to temporarily or permanently store instructions and data that cause machine 700 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 716) for execution by a machine 700 such that the instructions, when executed by one or more processors 710 of the machine 700, cause the machine 700 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 750 may include a wide variety of hardware components adapted to receive input, provide output, produce output, transmit information, exchange information, capture measurements, and so on. The specific I/O components 750 included in a particular machine will depend on the type and/or function of the machine. For example, mobile devices such as mobile phones may include a touch input device, whereas a headless server or IoT device may not include such a touch input device. The particular examples of I/O components illustrated in FIG. 7 are in no way limiting, and other types of components may be included in machine 700. The grouping of I/O components 750 are merely for simplifying this discussion, and the grouping is in no way limiting. In various examples, the I/O components 750 may include user output components 752 and user input components 754. User output components 752 may include, for example, display components for displaying information (for example, a liquid crystal display (LCD) or a projector), acoustic components (for example, speakers), haptic components (for example, a vibratory motor or force-feedback device), and/or other signal generators. User input components 754 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 750 may include biometric components 756, motion components 758, environmental components 760, and/or position components 762, among a wide array of other physical sensor components. The biometric components 756 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 758 may include, for example, acceleration sensors (for example, an accelerometer) and rotation sensors (for example, a gyroscope). The environmental components 760 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 762 may include, for example, location sensors (for example, a Global Position System (GPS) receiver), altitude sensors (for example, an air pressure sensor from which altitude may be derived), and/or orientation sensors (for example, magnetometers).

The I/O components 750 may include communication components 764, implementing a wide variety of technologies operable to couple the machine 700 to network(s) 770 and/or device(s) 780 via respective communicative couplings 772 and 782. The communication components 764 may include one or more network interface components or other suitable devices to interface with the network(s) 770. The communication components 764 may include, for example, components adapted to provide wired communication, wireless communication, cellular communication, Near Field Communication (NFC), Bluetooth communication, Wi-Fi, and/or communication via other modalities. The device(s) 780 may include other machines or various peripheral devices (for example, coupled via USB).

In some examples, the communication components 764 may detect identifiers or include components adapted to detect identifiers. For example, the communication components 764 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 764, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory storing executable instructions that, when executed, cause the processor alone or in combination with other processors to perform operations of:
obtaining program code that was input into a user interface of an integrated development environment;
analyzing the program code using a language model to cause the language model to generate a suggestion for completing the program code;
monitoring tokens generated by the language model using a code monitor as the language model is generating the tokens, the tokens representing partial code that has been generated by the language model based on the program code;
identifying a trigger point in the partial code using the code monitor;
querying a static analysis tool using the code monitor to obtain constraints on generation of subsequent tokens based on repository-level syntactic and semantic knowledge in response to detecting the trigger point; and
guiding generation of subsequent tokens by the language model based on the constraints to cause the language model to generate a syntactically and semantically correct suggestion for completing the program code.

2. The data processing system of claim 1, wherein guiding the generation of the subsequent tokens by the language model further comprises:
converting the constraints to masks for modifying logits of the language model, the logits representing a plurality of candidate tokens for the subsequent tokens; and
modifying the logits of the language model using the masks to cause the language model to eliminate candidates for the subsequent tokens that are inconsistent with the constraints from the static analysis tool.

3. The data processing system of claim 2, wherein the memory further includes instructions configured to cause the processor alone or in combination with other processors to perform operations of:
performing an update operation in which the constraints obtained from the static analysis tool are updated based on the subsequent tokens generated by the language model to generate updated constraints.

4. The data processing system of claim 3, wherein the memory further includes instructions configured to cause the processor alone or in combination with other processors to perform operations of:
guiding the generation of a subsequent token by the language model based on the updated constraints.

5. The data processing system of claim 2, wherein modifying the logits of the language model further comprises:
setting a value of logits associated with the plurality of candidate tokens for the subsequent tokens that are inconsistent with the constraints by setting the logits to a negative value.

6. The data processing system of claim 2, wherein the static analysis tool provides the constraints based on context information based on a code repository.

7. The data processing system of claim 6, wherein the context information includes external dependencies, intermediate artifacts, or both.

8. The data processing system of claim 1, wherein the constraints comprise one or more legal dereference names, a valid number of arguments, or a valid application programming interface (API) call consistent with an API ordering contract.

9. The data processing system of claim 1, wherein the constraints are static analysis constraints that ensure that the program code complies with a set of programming standards.

10. The data processing system of claim 1, wherein the code monitor communicates with the static analysis tool using Language Server Protocol.

11. A method implemented in a data processing system for generating program code, the method comprising:
obtaining program code that was input into a user interface of an integrated development environment;
analyzing the program code using a language model to cause the language model to generate a suggestion for completing the program code;
monitoring tokens generated by the language model using a code monitor as the language model is generating the tokens, the tokens representing partial code that has been generated by the language model based on the program code;
identifying a trigger point in the partial code using the code monitor;
querying a static analysis tool using the code monitor to obtain constraints on generation of subsequent tokens based on repository-level syntactic and semantic knowledge in response to detecting the trigger point; and
guiding generation of subsequent tokens by the language model based on the constraints to cause the language model to generate a syntactically and semantically correct suggestion for completing the program code.

12. The method of claim 11, wherein guiding the generation of the subsequent tokens by the language model further comprises:
converting the constraints to masks for modifying logits of the language model, the logits representing a plurality of candidate tokens for the subsequent tokens; and
modifying the logits of the language model using the masks to cause the language model to eliminate candidates for the subsequent tokens that are inconsistent with the constraints from the static analysis tool.

13. The method of claim 12, further comprising:
performing an update operation in which the constraints obtained from the static analysis tool are updated based on the subsequent tokens generated by the language model to generate updated constraints.

14. The method of claim 13, further comprising:
guiding the generation of a subsequent token by the language model based on the updated constraints.

15. The method of claim 12, wherein modifying the logits of the language model further comprises:
setting a value of logits associated with the plurality of candidate tokens for the subsequent tokens that are inconsistent with the constraints by setting the logits to a negative value.

16. A data processing system comprising:
a processor; and
a memory storing executable instructions that, when executed, cause the processor alone or in combination with other processors to perform operations of:
monitoring, using a code monitor, tokens generated by a language model in response to a prompt to cause the language model to generate a suggestion for completing program code, the tokens representing partial code that has been generated by the language model based on the program code;
querying a static analysis tool using the code monitor to obtain constraints on generation of subsequent tokens based on repository-level syntactic and semantic knowledge; and
guiding generation of subsequent tokens by the language model based on the constraints to cause the language model to generate a syntactically and semantically correct suggestion for completing the program code.

17. The data processing system of claim 16, wherein guiding the generation of the subsequent tokens by the language model further comprises:
converting the constraints to masks for modifying logits of the language model, the logits representing a plurality of candidate tokens for the subsequent tokens; and
modifying the logits of the language model using the masks to cause the language model to eliminate candidates for the subsequent tokens that are inconsistent with the constraints from the static analysis tool.

18. The data processing system of claim 17, wherein the memory further includes instructions configured to cause the processor alone or in combination with other processors to perform operations of:
performing an update operation in which the constraints obtained from the static analysis tool are updated based on the subsequent tokens generated by the language model to generate updated constraints.

19. The data processing system of claim 18, wherein the memory further includes instructions configured to cause the processor alone or in combination with other processors to perform operations of:
guiding the generation of a subsequent token by the language model based on the updated constraints.

20. The data processing system of claim 17, wherein modifying the logits of the language model further comprises:
setting a value of logits associated with the plurality of candidate tokens for the subsequent tokens that are inconsistent with the constraints by setting the logits to a negative value.
